(19) United States
(12) Patent Application Publication
(10) Pub. No.: US 2009/0035476 A1
(43) Pub. Date: Feb. 5, 2009

(54) Method for Forming Coating Film

(75) Inventors: Junya Uemura, Tokyo (JP); Masashi Takahashi, Tokyo (JP); Tsuyoshi Imamura, Osaka (JP); Taizo Nanke, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Nippon Paint Co. Ltd.

(21) Appl. No.: 12/180,581

(22) Filed: Jul. 28, 2008

(30) Foreign Application Priority Data
Jul. 30, 2007 (JP) 197860/2007

(51) Int. Cl. C08K 3/08; B05D 1/36

(52) U.S. Cl. 427/407.1; 524/547

(57) ABSTRACT

A method for forming a multi-layer coating film by forming an undercoating film, a glittering material-containing base coating film and a clear coating film in this order on a substrate to be coated, in which a glittering material-containing base coating material for forming the glittering material-containing base coating film contains colloid particles containing a noble metal and/or a metal, a coating film-forming resin, and a mixed solvent containing an ester organic solvent having a boiling point of from 70 to 130° C. and a glycol or glycol ether organic solvent having a boiling point of from 115 to 230° C. at a mass mixing ratio of from 2/8 to 5/5.

### BACKGROUND OF THE INVENTION

1. Field of the Invention

The present invention relates to a method for forming a multi-layer coating film having metallic gloss excellent in design property.

2. Related Art

In recent years, high design property is required for an appearance of an automobile body, an automobile part, such as an aluminum wheel, an electronic product, such as a mobile phone and a personal computer, and the like, and there is an importance for metallic gloss like mirror surface imparted to the surface of the products. As a technique therefor, a metal plating process and a metal vapor deposition process have been known, and metallic gloss is imparted to the surface by the technique to provide an appearance that is excellent in design property. However, the metal plating process has such defects that waste water and the like derived from the process brings about large environmental load, and a base material for the process is limited to those having electroconductivity. The metal vapor deposition process has such defects that a base material is necessarily placed in a vacuum or depressurized chamber, and the process cannot be applied to a large-size base material. Furthermore, a large-scale equipment is required in both the metal plating process and the metal vapor deposition process, and thus an alternate method is demanded from the standpoint of cost.

Under the circumstances, a technique of imparting metallic gloss by coating is being developed in recent years. For example, JP-A-11-343431 discloses a coating material containing metal fragments formed by pulverizing a metal vapor deposition film, such as an aluminum vapor deposition film, as a glittering pigment, and a method for forming a coating film using the coating material, and discloses that a coating film having an adequate metallic gloss can be obtained by using the coating material. However, the metallic gloss of the coating film is not as strong as mirror gloss, and thus a coating film forming technique that can impart stronger gloss is demanded from the standpoint of design property.

JP-A-2000-239853 discloses a coating material containing colloid particles of a noble metal or copper and a method for forming a metal thin film by using the coating material, and discloses that the metal thin film has metallic gloss like plating. However, the coating material disclosed in JP-A-2000-239853 is to satisfy demanded capability in special purposes, and further improvements are still required for use as a general coating composition. Specifically, the coating composition is for forming a metal thin film for an electrode and wiring in an electronic parts or the like, and JP-A-2000-239853 fails to disclose formation of a coating film having high design property, such as mirror gloss.

In order to form a multi-layer coating film having metallic gloss excellent in design property, in general, it is necessary to form a coating film containing a glittering material as a thin, uniform and continuous coating film, and it is preferable to reduce the contents of the components other than the pigment in the coating film. For attaining the requirements, it is necessary to provide a coating technique capable of forming a thin continuous coating film, but the coating technique has not yet been developed.

Examples of the technique for forming a thin continuous coating film include a technique of coating a coating composition uniformly on a substrate to be coated, and a technique of curing the coating material while maintaining the uniform state. It has been known in these techniques that the state of the coating film can be controlled by selecting an additive and a coating film-forming resin, but there has been no instance of applying to a coating material having the particular formulation mentioned above. There arises another problem upon demanding excellent design property to a multi-layer coating film. Specifically, such a phenomenon as white turbidity occurs depending on the combination of the components of the coating material, and therefore, conventional techniques relating to an additive and a coating film-forming resin cannot be simply utilized. In particular, it is important to solve the problem of white turbidity upon demanding metallic gloss like mirror surface. The coating technique for imparting metallic gloss to a surface of a product is being developed as described above, but the technique is not yet perfected, and further development is being demanded.

### SUMMARY OF THE INVENTION

An object of the present invention is to provide a method for forming a thin continuous coating film having metallic gloss excellent in design property.

As a result of earnest investigations for attaining the aforementioned and other objects by the inventors, it has been found that the aforementioned and other objects are attained by a method for forming a multi-layer coating film using a glittering material-containing base coating composition that contains colloid particles containing a noble metal and/or a metal as a pigment, and further contains a coating film-forming resin and a specific mixed solvent.

The invention relates to a method for forming a multi-layer coating film by forming an undercoating film, a glittering material-containing base coating film and a clear coating film in this order on a substrate to be coated, a glittering material-containing base coating material for forming the glittering material-containing base coating film containing colloid particles containing a noble metal and/or a metal, a coating film-forming resin, and a mixed solvent containing an ester organic solvent having a boiling point of from 70 to 130° C. and a glycol or glycol ether organic solvent having a boiling point of from 115 to 230° C. at a mass mixing ratio of from 2/8 to 5/5.

According to the invention, a method for forming a multi-layer coating film having metallic gloss excellent in design property is provided. The glittering material-containing base coating material used in the invention is controlled in state in stages of from storing to curing on the substrate to be coated, mainly by the characteristics of the solvent, and the use of the coating material provides a glittering material-containing base coating film that is a thin, uniform and continuous coating film and has metallic gloss excellent in design property. The term “having metallic gloss” referred herein means the gloss inherent to the noble metal when the noble metal is used as the colloid particles, and means the gloss inherent to the metal when the metal is used as the colloid.

### DESCRIPTION OF THE PREFERRED EMBODIMENTS

In the method for forming a multi-layer coating film of the invention, an undercoating film, a glittering material-containing base coating film and a clear coating film are formed in this order on a substrate to be coated, by using a specific glittering material-containing base coating material.

### [Glittering Material-Containing Base Coating Material]

The glittering material-containing base coating material used in the invention contains colloid particles containing a noble metal and/or a metal (which may be hereinafter referred to as “a noble metal or the like” in some cases) as a glittering material, and further contains a coating film-forming resin and a mixed solvent containing an ester organic solvent having a boiling point of from 70 to 130° C. and a glycol or glycol ether organic solvent having a boiling point of from 115 to 230° C. at a mass mixing ratio of from 2/8 to 5/5. The solid content of the glittering material-containing base coating material upon coating is preferably from 1 to 5% by mass, and more preferably from 1.2 to 4% by mass. In the case where the solid content is less than 1% by mass, a continuous coating film may not be formed, and in the case where the solid content exceeds 5% by mass, the colloid particles may not be in the form of fine particles. The concentration of the colloid particles (PWC) containing a noble metal or the like in the solid content of the coating material upon coating is preferably from 80 to 98% by mass, and more preferably from 85 to 98% by mass. In the case where the concentration is less than 80% by mass, metallic gloss may not be obtained, and in the case where the concentration exceeds 98% by mass, a sufficient amount of the resin component for forming the coating film may not be obtained, and it is difficult to form a uniform continuous film. The composition of the solid content of the coating material other than the colloid particles containing a noble metal or the like may be appropriately determined depending on purposes, and the content of the coating film-forming resin is preferably from 1 to 15% by mass, and more preferably from 5 to 15% by mass, based on the solid content of the colloid particles containing a noble metal or the like. In the case where the content of the resin is less than 1% by mass, a continuous coating film may not be formed, and the content of the resin exceeds 15% by mass, a coating film having metallic gloss excellent in design property may not be obtained.

The glittering material-containing base coating material used in the invention is obtained with the aforementioned special composition, in which the solid content in the coating material is significantly small upon coating, and the solid content is mostly occupied with the colloid particles of a noble metal or the like as a pigment. The invention has been completed through detailed investigations relating to combinations of components of the coating material. Specifically, the high concentration of the colloid particles (PWC) provides a coating film having excellent metallic gloss, the use of the colloid particles as a pigment and the reduction in solid content in the coating material provide a thin coated film, and the use of the coating film-forming resin provides a uniform coating film exhibiting sufficient performance. Furthermore, the specific mixed solvent is used to maintain the uniformity of the coating material in stages of from storing to curing on the substrate to be coated. The combination of the components of the coating material does not bring about reduction in design property due to white turbidity or the like.

The colloid particles containing a noble metal and/or a metal in the glittering material-containing base coating material used in the invention have a particle diameter of about from 1 to 100 nm, and the colloid particles can be obtained by a known method, such as a liquid phase method and a gas phase method. For example, the colloid particles are obtained by a production step of reducing a compound of a noble metal or a metal in the presence of a polymeric pigment dispersing agent to provide colloid particles of a noble metal or the like, and a concentrating step of subjecting the colloid particle solution of a noble metal or the like to ultrafiltration. The particle diameter of the colloid particles is measured by a dynamic light scattering method using laser light and expressed in terms of median diameter on volume basis.

The noble metal used in the glittering material-containing base coating material used in the invention is not particularly limited, and examples thereof include gold, silver, ruthenium, rhodium, palladium, osmium, iridium and platinum. Among these, gold, silver, platinum and palladium are preferred, and silver and gold are particularly preferred owing to high glossiness.

The metal used in the glittering material-containing base coating material used in the invention is not particularly limited, and examples thereof include copper, nickel, bismuth, indium, cobalt, zinc, tungsten, chromium, iron, molybdenum, tantalum, manganese, tin and titanium.

The colloid particle containing a noble metal and/or a metal used in the invention may contain at least two selected from the noble metals and the metals mentioned above in the form of composite (composite metal colloid) or in the form of simple mixture (mixed colloid). Examples of the composite metal colloid include composite metal colloid particles having a core/shell structure. The composite metal colloid referred herein means colloid containing colloid particles, each of which is constituted by two or more kinds of metals, and the mixed colloid referred herein means colloid obtained by mixing two or more kinds of colloid.

The compound of a noble metal or the like used for preparing the colloid particles of a noble metal or the like is not particularly limited as far as it contains the noble metal or the like, and examples thereof include tetrachlorogold(III) acid tetrahydride (chlorauric acid), silver nitrate, silver acetate, silver(IV) perchlorate, hexachloroplatinum(IV) hexahydrate (chloroplatinic acid), potassium chloroplatinate, copper(II) chloride dihydrate, copper(II) acetate monohydrate, copper(II) sulfate, palladium(II) chloride dihydrateandrhodium(III) trichloride trihydrate. These may be used solely or in combination of two or more kinds thereof.

In the method for preparing the colloid particles described above, the compound of a noble metal or the like is preferably used in such a manner that the molar concentration of the noble metal or the like in the solution before subjecting to ultrafiltration is 0.01 mol/L or more. In the case where the concentration is less than 0.01 mol/L, the molar concentration of the noble metal or the like in the resulting colloid particle solution of the noble metal or the like is too low to provide deteriorated efficiency. The concentration is more preferably 0.05 mol/L or more, and further preferably 0.1 mol/L or more, from the standpoint of efficiency.

The polymeric pigment dispersing agent is a high-molecular weight copolymer having amphipathic property containing a functional group having high affinity with the colloid particles and a part having affinity to a solvent, and is ordinarily used as a pigment dispersing agent upon producing a pigment paste.

In the method for preparing the colloid particles, the polymeric pigment dispersing agent is present along with the colloid particles of a noble metal or the like, and it is considered that the polymeric pigment dispersing agent stabilizes dispersed state of the colloid particles of a noble metal or the like in the solvent. The number average molecular weight of the polymeric pigment dispersing agent is preferably from 1,000 to 1,000,000. In the case where the number average molecular weight is less than 1,000, the function of stabilizing the dispersed state may be insufficient, and in the case where it exceeds 1,000,000, the dispersing agent may be difficult to handle due to high viscosity. From the viewpoints, the number average molecular weight is more preferably from 2,000 to 500,000, and further preferably from 4,000 to 500,000. The number average molecular weight is obtained by a gel permeation chromatography (GPC) method based on polystyrene standard.

The polymeric pigment dispersing agent is not particularly limited as far as the aforementioned properties are satisfied, and examples thereof include those disclosed in JP-A-11-80647. Commercially available products may be used therefor, and examples thereof include Solsperse 20000, Solsperse 24000, Solsperse 26000, Solsperse 27000, Solsperse 28000, Solsperse 32550, Solsperse 35100, Solsperse 37500 and Solsperse 41090 (all produced by Lubrizol Corporation), Disperbyk 160, Disperbyk 161, Disperbyk 162, Disperbyk 163, Disperbyk166, Disperbyk 170, Disperbyk 180, Disperbyk 181, Disperbyk182, Disperbyk 183, Disperbyk 184, Disperbyk 190, Disperbyk 191, Disperbyk 192, Disperbyk 2000 and Disperbyk 2001 (all produced by BYK Chemie GmbH), Polymer 100, Polymer 120, Polymer 150, Polymer 400, Polymer 401, Polymer 402, Polymer 403, Polymer 450, Polymer 451, Polymer 452, Polymer 453, EFKA-46, EFKA-47, EFKA-48, EFKA-49, EFKA-1501, EFKA-1502, EFKA-4540 and EFKA-4550 (all produced by EFKA Additives Co. Ltd.), Flowlen DOPA-158, Flowlen DOPA-22, Flowlen DOPA-17, Flowlen G-700, Flowlen TG-720W, Flowlen 730W, Flowlen 740W and Flowlen 745W (all produced by Kyoeisha Chemical Co., Ltd.), Adisper PA111, Adisper PB711, Adisper PB811, Adisper PB812 and Adisper PW911 (all produced by Ajinomoto Co., Inc.), and Joncryl 678, Joncryl 679 and Joncryl 62 (all produced by Johnson Polymer, Inc.). These may be used solely or in combination of two or more kinds thereof.

The using amount of the polymeric pigment dispersing agent is preferably 30% by mass or less based on the total amount of the noble metal or the like in the compound of a noble metal or the like and the polymeric pigment dispersing agent. In the case where the amount exceeds 30% bymass, the concentration of the noble metal or the like in the solid content in the solution may not be increased to an intended level even though the solution is subjected to ultrafiltration in the concentrating step later. From the viewpoints, the using amount of the polymeric pigment dispersing agent is more preferably 20% by mass or less, and further preferably 10% by mass or less, based on the total amount of the noble metal or the like in the compound of a noble metal or the like and the polymeric pigment dispersing agent.

Upon reducing the compound of a noble metal or the like in the method for preparing the colloid particles, an amine is preferably used as a reducing agent. For example, an amine is added to the solution of the compound of a noble metal or the like and the polymeric pigment dispersing agent, and the solution is mixed and stirred, whereby the noble metal ion or the metal ion is reduced to a noble metal or a metal. The use of an amine enables reduction of the compound of a noble metal or the like at a reaction temperature of about from 5 to 100° C., and preferably from 20 to 80° C., without the use of a reducing agent having high risk and harmfulness and without the use of heating or a special light irradiation apparatus.

The amine is not particularly limited, and those shown in JP-A-11-80647 may be used. Examples thereof include an aliphatic amine, such as propylamine, butylamine, hexylamine, diethylamine, dipropylamine, dimethylethylamine, diethylmethylamine, triethylamine, ethylenediamine, N,N,N′,N′-tetramethylethylenediamine, 1,3-diaminopropane, N,N,N′,N′-tetramethyl-1,3-diaminopropane, triethylenetetramine and tetraethylenepentamine; an alicyclic amine, such as piperidine, N-methylpiperidine, piperazine, N,N′-dimethylpiperazine, pyrrolidine, N-methylpyrrolidine and morpholine; an aromatic amine, such as aniline, N-methylaniline, N,N-dimethylaniline, toluidine, anisidine and phenetidine; and an aralkylamine, such as benzylamine, N-methylbenzylamine, N,N-dimethylbenzylamine, phenethylamine, xylylenediamine and N,N,N′,N′-tetramethylxylylenediamine. Examples of the amine also include an alkanolamine, such as methylaminoethanol, dimethylaminoethanol, triethanolamine, ethanolamine, diethanolamine, methyldiethanolamine, propanolamine, 2-(3-aminopropylamino)ethanol, butanolamine, hexanolamine and dimethylaminopropanol. These may be used solely or in combination of two or more kinds thereof. Among these, an alkanolamine is preferred, and dimethylaminoethanol is more preferred.

Examples of the reducing agent other than the amine include an alkali metal borohydride, such as sodium borohydride, a hydrazine compound, hydroxylamine, citric acid, tartaric acid, ascorbic acid, formic acid, formaldehyde, a dithionite salt and a sulfoxylate salt derivative. Among these, citric acid, tartaric acid and ascorbic acid are preferred since they are easily available. These may be used solely or in combination with the amine, and in the case where the amine is used in combination with citric acid, tartaric acid or ascorbic acid, citric acid, tartaric acid or ascorbic acid is preferably used in the form of salt. Citric acid and a sulfoxylate salt derivative can be improved in reducing capability thereof by using in combination with an iron(II) ion.

The addition amount of the reducing compound is preferably such an amount that is equal to or larger than the amount necessary for reducing the noble metal or the like in the compound of a noble metal or the like. In the case where the amount of the reducing compound is less than the necessary amount, the reduction may be insufficiently performed. The upper limit of the addition amount is not particularly determined, and it is preferably 30 times or less, and more preferably 10 times or less, the amount necessary for reducing the noble metal or the like in the compound of a noble metal or the like. In addition to the method of chemically reducing by addition of the reducing compound, a method of reducing by radiating light by using a high-pressure mercury lamp may also be employed.

The method for adding the reducing compound is not particularly limited, and for example, the reducing agent may be added after adding the polymeric pigment dispersing agent. In this case, the polymeric pigment dispersing agent is dissolved in a solvent, and one of the reducing compound and the compound of a noble metal or the like is further dissolved therein to form a solution, in which the other of the reducing compound and the compound of the noble metal or the like is dissolved to perform reduction. As another example of the method of adding the reducing compound, the polymeric pigment dispersing agent and the reducing compound are mixed in advance, and the mixture is added to a solution of the compound of a noble metal or the like.

The colloid particle solution of a noble metal or the like thus obtained by the reducing step is subjected to ultrafiltration to provide a colloid particle solution that has a high concentration and a less amount of impurities (such as miscellaneous ions, salts, amines and the polymeric pigment dispersing agent) and is suitable for preparing a glittering material-containing base coating material. The content of the noble metal or the metal in the solid content of the solution after subjecting to the treatment is preferably from 83 to 99% by mass, more preferably from 90 to 98% by mass, and further preferably from 93 to 98% by mass. In the case where the glittering material-containing base coating material is prepared by using a solution having a content of the noble metal or the metal of less than 83% by mass, problems may occur in glossiness with moderate heating conditions upon forming the coating film. In the case where the content of the noble metal or the like exceeds 99% by mass, the dispersion stability of the colloid particles may be impaired.

The content of the noble metal or the metal in the solid content contained in the colloid particle solution obtained in the aforementioned manner is larger than that obtained by a conventional manner. Therefore, the use of the glittering material-containing base coating material containing the colloid particles can provide a coating film that has high glossiness and a metallic appearance without metallic particle appearance, which occurs with a plating-like coating film, even when the heating conditions upon forming the coating film are moderate as compared to the ordinary manner. Accordingly, a coating film that has high glossiness and a metallic appearance without metallic particle appearance, which occurs with a plating-like coating film, can be formed on a base material that has a relatively low heat resisting temperature, such as plastics and paper.

Examples of the coating film-forming resin contained in the glittering material-containing base coating material used in the invention include an acrylic resin, a polyester resin, an alkyd resin, an epoxy resin, a polyurethane resin and a polyether resin, and the coating film-forming resin may be used solely or in combination of two or more kinds thereof. The coating film-forming resin includes those having curing property and those of lacquer type, and in general, those having a curing functional group are used. The resin having a curing functional group is used by mixing with a crosslinking agent, such as an amino resin, a (block) isocyanate compound, an amine compound, a polyamide compound, an imidazole compound, an imidazoline compound and a polybasic carboxylic acid, and the curing reaction thereof can proceed by heating or at ordinary temperature. A lacquer type coating film-forming resin having no curing functional group and a coating film-forming resin having a curing functional group may be used in combination. The crosslinking agent is preferably at least one of an amino resin and a block polyisocyanate compound. In the case where the crosslinking agent is used, the ratio of the coating film-forming resin and the crosslinking agent is generally from 99 to 50% by mass for the coating film-forming resin and from 1 to 50% by mass for the crosslinking agent, and preferably from 99 to 70% by mass for the coating film-forming resin and from 1 to 30% by mass for the crosslinking agent. In the case where the ratio of the crosslinking agent is less than 1% by mass (i.e., the ratio of the coating film-forming resin exceeds 99% by mass), crosslinking in the coating film may not proceed sufficiently. In the case where the ratio of the crosslinking agent exceeds 50% by mass (i.e., the ratio of the coating film-forming resin is less than 50% by mass), on the other hand, the storage stability of the coating material is deteriorated, and the curing rate thereof is increased to deteriorate the appearance of the coating film.

Examples of the acrylic resin include a copolymer of an acrylic monomer and another ethylenic unsaturated monomer. Examples of the acrylic monomer that can be used in the copolymer include ester compounds of acrylic acid and methacrylic acid with methyl, ethyl, propyl, n-butyl, i-butyl, t-butyl, 2-ethylhexyl, lauryl, phenyl, benzyl, 2-hydroxyethyl, 2-hydroxypropyl, 4-hydroxybutyl and the like, a ring-opening adduct of caprolactone of 2-hydroxyethyl acrylate or methacrylate, glycidyl acrylate, glycidyl methacrylate, acrylamide, methacrylamide, N-methylolacrylamide, a (meth)acrylate ester of a polyhydric alcohol, acrylic acid, methacrylic acid and a phosphoric acid group-containing (meth)acrylate ester described later. Examples of the ethylenic unsaturated monomer capable of being polymerized with the acrylic monomer include styrene, α-methylstyrene, itaconic acid, maleic acid and vinyl acetate.

Examples of the polyester resin include a saturated polyester resin and an unsaturated polyester resin, and specifically include a condensate obtained by condensing a polybasic acid and a polyhydric alcohol under heating. Examples of the polybasic acid include a saturated polybasic acid, such as phthalic anhydride, terephthalic acid and succinic acid, and an unsaturated polybasic acid, such as maleic acid, maleic anhydride and fumaric acid. Examples of the polyhydric alcohol include a dihydric alcohol, such as ethylene glycol and diethylene glycol, and a trihydric alcohol, such as glycerin and trimethylolpropane.

Examples of the alkyd resin include an alkyd resin obtained by reacting the polybasic acid and the polyhydric alcohol with a modifying agent, such as a fat or a fatty acid (such as soybean oil, linseed oil, coconut oil and stearic acid) and a natural resin (such as rosin and amber).

Examples of the epoxy resin include a resin obtained by reacting a bisphenol and epichlorohydrin. Examples of the bisphenol include bisphenol A and bisphenol F. Examples of the bisphenol type epoxy resin include Epikote 828, Epikote 1001, Epikote 1004, Epikote 1007 and Epikote 1009 (all produced by Shell Chemicals Ltd.), and those obtained by chain extension with a suitable chain extending agent may also be used.

Examples of the polyurethane resin include a resin having a urethane bond obtained by reacting a polyol component, such as an acrylate, a polyester, a polyether and a polycarbonate, and a polyisocyanate compound. Examples of the polyisocyanate compound include 2,4-tolylenediisocyanate (2,4-TDI), 2,6-tolylenediisocyanate (2,6-TDI), a mixture thereof (TDI), diphenylmethane-4,4′-diisocyanate (4,4′-MDI), diphenylmethane-2,4′-diisocyanate (2,4′-MDI), a mixture thereof (MDI), naphthalene-1,5-diisocyanate (NDI), 3,3′-dimethyl-4,4′-biphenylenediisocyanate, xylylenediisocyanate (XDI), dicyclohexylmethanediisocyanate (hydrogenated HDI), isophoronediisocyanate (IPDI), hexamethylenediisocyanate (HDI) and hydrogenated xylylenediisocyanate (HXDI).

Examples of the polyether resin, which is a polymer or copolymer having an ether bond, include a polyether resin having at least two hydroxyl group per one molecule, such as a polyoxyethylene polyether, a polyoxypropylene polyether, polyoxybutylene polyether and a polyether derived from an aromatic polyhydroxy compound, e.g., bisphenol A and bisphenol F. Examples thereof also include a carboxyl group-containing polyether resin obtained by reacting the polyether resin with a reactive derivative, for example, a polybasic carboxylic acid, such as succinic acid, adipic acid, sebacic acid, phthalic acid, isophthalic acid, terephthalic acid and trimellitic acid, and anhydrides thereof.

Preferred examples of the coating film-forming resin include a acrylic resin and a polyester resin with an acrylic resin being particularly preferred, and an acrylic resin having a phosphoric acid group (which is hereinafter referred to as a phosphoric acid group-containing acrylic resin) is further preferred. The content of the solid content of the phosphoric acid group-containing acrylic resin in the solid content of the coating film-forming resin is preferably from 30 to 100% by mass, andmore preferably from 50 to 100% by mass. In the case where the content of the solid content of the phosphoric acid group-containing acrylic resin is less than 30% by mass, the water resistance and the adhesiveness may be affected.

Examples of the phosphoric acid group-containing acrylic resin include an acrylic resin obtained by copolymerizing a monomer represented by the following general formula (I) and another ethylenic unsaturated monomer:

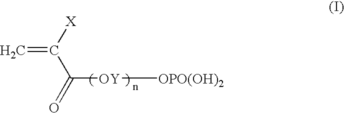

wherein X represents a hydrogen atom or a methyl group; Y represents an alkylene group having from 2 to 4 carbon atoms; and n represents an integer of from 3 to 30.

The monomer represented by the general formula (I) can be synthesized, for example, in such a manner that an alkylene oxide is added to (meth)acrylic acid by addition reaction to form a polyalkylene glycol monoester, which is then reacted with phosphorus oxychloride to monoesterize the phosphoric acid, and thereafter the resulting product is hydrolyzed. The monomer can be synthesized by an ordinary method by using orthophosphoric acid, metaphosphoric acid, phosphoric anhydride, phosphorus trichloride, phosphorus pentachloride or the like instead of phosphorus oxychloride.

In the addition reaction, the using amount of the alkylene oxide may be basically a stoichiometric amount, i.e., n mol corresponding to n in the general formula (I), and in general is from 3 to 30 mol, preferably from 4 to 15 mol, and particularly preferably from 5 to 10 mol, per 1 mol of (meth)acrylic acid. Examples of the alkylene oxide include those having from 2 to 4 carbon atoms. Specific examples thereof include ethylene oxide, propylene oxide and butylene oxide. Examples of a catalyst used in the reaction include potassium hydroxide and sodium hydroxide. Examples of a solvent used in the reaction include N-methylpyrrolidone. The reaction temperature may be from 40 to 200° C., and the reaction time may be from 0.5 to 5 hours.

After the addition reaction, monoesterification is carried out with phosphorus oxychloride. The esterification may be carried out according to an ordinary method, and for example, at a temperature of from 0 to 100° C. for a period of from 0.5 to 5 hours. The using amount of phosphorus oxychloride may be a stoichiometric amount, and for example, from 1 to 3 mol per 1 mol of the product of addition reaction.

Thereafter, the resulting product is hydrolyzed according to an ordinary method to provide a monomer (i) represented by the general formula (I). Specific examples of the monomer (i) include acid phosphoxy hexa(oxypropylene)monomethacrylate and acid phosphoxy dodeca(oxypropylene)monomethacrylate.

The monomer (i) and another ethylenic unsaturated monomer (ii) are copolymerized by an ordinary method to provide the phosphoric acid-containing acrylic resin. Examples of the ethylenic unsaturated monomer (ii) include acrylic monomers and ethylenic unsaturated monomers described for synthesis of the acrylic resin. Examples of the copolymerization method include such a method that a mixture of monomers is mixed with a known polymerization initiator (such as azobisisobutyronitrile), and the mixture is added dropwise to a solvent (such as propylene glycol monoethyl ether) having been heated to a polymerizable temperature, followed by aging. While the polymerization conditions may be appropriately selected, for example, the polymerization temperature may be from 80 to 150° C., and the polymerization time may be from 1 to 8 hours.

In the composition for the polymerization reaction, the amount of the monomer (ii) is preferably from 200 to 5,000 parts by mass per 100 parts by mass of the monomer (i). In the case where the amount of the monomer (ii) is less than 200 parts by mass, the water resistance may be deteriorated, and in the case where the amount of the monomer (ii) exceeds 5,000 parts by mass, there are cases where the effect of the phosphoric acid group cannot be exhibited.

The phosphoric acid group-containing acrylic resin preferably has an acid value of phosphoric acid groups of from 70 to 150 mgKOH/g, a total acid value including acid values of other acid groups of from 70 to 200 mgKOH/g, a hydroxyl value of from 50 to 220 mgKOH/g and a number average molecular weight of from 2,000 to 8,000.

In the case where the acid value of phosphoric acid groups of the phosphoric acid group-containing acrylic resin is less than 70 mgKOH/g, the glittering material-containing base coating film may be broken, and the water resistance may be further deteriorated. In the case where it exceeds 150 mgKOH/g, the storage stability of the glittering material-containing base coating material may be deteriorated. From the viewpoints, the acid value of phosphoric acid groups is more preferably from 75 to 120 mgKOH/g.

In the case where the total acid value including acid values of other acid groups of phosphoric acid groups of the phosphoric acid group-containing acrylic resin is less than 70 mgKOH/g, the glittering material-containing base coating film may be broken, and the water resistance may be further deteriorated. In the case where it exceeds 200 mgKOH/g, the storage stability of the glittering material-containing base coating material may be deteriorated. From the viewpoints, the total acid value is more preferably from 75 to 150 mgKOH/g.

In the case where the hydroxyl value of the phosphoric acid group-containing acrylic resin is less than 50 mgKOH/g, the water resistance may be deteriorated, and in the case where it exceeds 220 mgKOH/g, results of water resistance test may be deteriorated due to blister. From the viewpoints, the hydroxyl value is more preferably from 70 to 180 mgKOH/g.

In the case where the number average molecular weight of the phosphoric acid group-containing acrylic resin is less than 2,000, the glittering material-containing base coating film maybe broken, and the curing property may be deteriorated. In the case where it exceeds 8,000, the appearance of the coating film may be deteriorated, and the handleability of the coating material may be deteriorated due to high viscosity. From the viewpoints, the number average molecular weight is more preferably from 3,000 to 6,000.

The glittering material-containing base coating material preferably contains the phosphoric acid group-containing acrylic resin in an amount of from 0.01 to 20 parts by mass, more preferably from 0.1 to 15 parts by mass, and further preferably from 0.2 to 13 parts by mass, per 100 parts by mass of the solid content of the coating material. In the case where the content of the phosphoric acid group-containing acrylic resin is too small, the glittering material-containing base coating film may be broken. In the case where the content of the phosphoric acid group-containing acrylic resin is too large, there is such a tendency that the appearance of the coating film is deteriorated.

In the invention, a mixed solvent of (A) an ester organic solvent having a boiling point of from 70 to 130° C. and (B) a glycol or glycol ether organic solvent having a boiling point of from 115 to 230° C. is used. The content ratios of the solvents in the mixed solvent is from 2/8 to 5/5, and preferably from 3/7 to 5/5, in terms of a mass ratio of the solvent (A) and the solvent (B). In the case where the boiling points of the solvents are lower than the lower limits, the appearance of the coating film may be deteriorated, and in the case where they exceed the upper limits, the coating film may be broken. In the case where the mass ratio is less than the lower limit, the appearance of the coating film may be deteriorated, and in the case where it exceeds the upper limit, the coating film may be broken.

In the invention, the use of the mixed solvent improves affinity with the colloid particles containing a noble metal or the like and the coating film-forming resin. As a result, the uniform state of the coating material can be maintained in stages of from storing to curing on the substrate to be coated, whereby a uniform thin coating film can be formed. By using the combination of solvents having different boiling points, the curing time and the state of the coating film upon curing the coating film can be controlled, whereby the coating film can be cured while maintaining the uniform state. As a result, a coating film having metallic gloss excellent in design property can be formed.

Examples of the solvent (A) include ethyl acetate, isopropyl acetate, butyl acetate, isobutyl acetate, methyl propionate and propyl acetate, and examples of the solvent (B) include ethylene glycol monomethyl ether, ethylene glycol monoethyl ether, ethylene glycol isopropyl ether, ethylene glycol 2-ethylhexyl ether, 3-methyl-3-methoxybutanol, 3-methoxybutanol, ethylene glycol monohexyl ether, ethylene glycol monobutyl ether, diethylene glycol monomethyl ether, diethylene glycol monoethyl ether, diethylene glycol monoethyl ether acetate, propylene glycol monomethyl ether and propylene glycol monoethyl ether.

The solvent (A) may be used solely or in combination of two or more kinds thereof. The solvent (B) may be used solely or in combination of two or more kinds thereof.

The glittering material-containing base coating material may contain, in addition to the aforementioned components, polyamide wax, which is a lubricating dispersion of an aliphatic amide, polyethylene wax, which is a colloidal dispersion mainly containing oxidized polyethylene, a sedimentation preventing agent, a curing catalyst, an ultraviolet ray absorbent, alight stabilizer, an antioxidant, a leveling agent, a surface conditioner, such as silicone and an organic polymer, a dripping preventing agent, a thickening agent, a defoaming agent, a lubricant, a crosslinked polymer particles (microgel) and the like in such amounts that do not impair the advantages of the invention.

In the method for forming a coating film of the invention, an undercoating film, a glittering material-containing base coating film and a clear coating film are formed in this order on a substrate to be coated, and the glittering material-containing base coating material is used for forming the glittering material-containing base coating film. The coating layers of the coating films may be formed by a wet-on-wet method or a wet-on-dry method.

### [Substrate to be Coated]

The substrate to be coated in the invention is not particularly limited, and examples thereof include a metal, such as iron, aluminum, copper and alloys thereof; an inorganic material, such as glass, cement and concrete; a plastic material, such as a resin material, e.g., a polyethylene resin, a polypropylene resin, an ethylene-vinyl acetate copolymer resin, a polyamide resin, an acrylic resin, a vinylidene chloride resin, a polycarbonate resin, a polyurethane resin and an epoxy resin, and various kinds of FRP; and natural and synthetic materials, such as wood, paper and a fiber material, such as cloth. Preferred examples of the substrate to be coated include a metal, such as iron, aluminum, copper and alloys thereof, and the method of the invention can be favorably applied to coating of an automobile body and an automobile part, such as an aluminum wheel.

### [Undercoating Film]

In the invention, the undercoating film is formed on the substrate to be coated. The method for forming the undercoating film is not particularly limited, and the undercoating film may be formed by spray coating or electrodeposition coating of a solution type (organic solvent type or aqueous type) coating material or spray coating of a powder coating material.

In the case where the substrate to be coated is an automobile body or an automobile part, the substrate to be coated is preferably subjected to a degreasing treatment or a chemical conversion treatment in advance, and a base coating film formed of an electrodeposition coating film is preferably formed. In the case where the substrate to be coated is a cast or forged aluminum wheel as the automobile part, a base coating film formed of a clear powder coating material or the like is preferably formed.

The dry film thickness of the undercoating film used in the invention varies depending on purposes and may be in a range of from 5 to 100 μm, and preferably from 7 to 80 μm. In the case where the thickness of the undercoating film exceeds 100 μm, the sharpness may be lowered, and the coating film may suffer unevenness or flowage. In the case where the thickness is less than 5 μm, the hiding power may become insufficient to cause breakage of the coating film.

### [Glittering Material-Containing Base Coating Film]

In the invention, the glittering material-containing base coating material is coated on the undercoating film and then heated to form the glittering material-containing base coating film. The coating method of the glittering material-containing base coating material is not particularly limited, and for example, the coating material may be coated by using a coating equipment, such as a spray coater, a spin coater, a roll coater, a silk screen and an ink-jet device, by dipping, and by electrophoresis. Among the coating methods, a spray coating method is preferred since a thin uniform coating film can be formed. The heating method is not particularly limited, and for example, a gas furnace, an electric furnace, an IR furnace and the like may be used as a heating furnace.

The coating amount of the glittering material-containing base coating material may be arbitrarily determined depending on purposes since it varies depending on the concentration of the colloid particles of a noble metal or the like, the coating method and the like. The dry film thickness of the glittering material-containing base coating film is not particularly limited and is generally from 0.01 to 1 μm, and preferably from 0.02 to 0.3 μm.

### [Clear Coating Film]

In the invention, a clear coating film is formed on the glittering material-containing base coating film. At least one layer of the clear coating film is necessary for protecting the glittering material-containing base coating film. A clear coating material used for the clear coating film is not particularly limited, and examples thereof include a colorless clear coating material, a matte clear coating material and a top color clear coating material, which may be appropriately selected depending purposes. The clear coating materials may be used in combination to form a clear coating film having two or more layers.

As the colorless clear coating material, a colorless clear coating material that has been ordinarily used as a finish coating may be used, and for example, a mixture of a thermosetting resin and crosslinking agent may be used. The thermosetting resin may be at least one selected from an acrylic resin, a polyester resin, a fluorine resin, an epoxy resin, a polyurethane resin, a polyether resin and modified resins thereof. A solution type coating material and an aqueous coating material may also be used, and may be a one-component coating material or a two-component resin, such as a two-component urethane resin coating material.

The colorless clear coating material may contain an additive, such as a modifier, an ultraviolet ray absorbent, a leveling agent, a dispersing agent and a defoaming agent, in such a range that the transparency thereof is not impaired.

The dry film thickness of the colorless clear coating film is preferably from 10 to 80 μm, and in the case where the dry film thickness is outside the range, the appearance of the coating film may be insufficient. The thickness of the colorless clear coating film is more preferably from 20 to 50 μm.

The matte clear coating material contains a vehicle and a matte agent. The vehicle may be one that has been ordinarily used as a finish coating, and for example, a mixture of a thermosetting resin and crosslinking agent may be used. The thermosetting resin may be at least one selected from an acrylic resin, a polyester resin, a fluorine resin, an epoxy resin, a polyurethane resin, a polyether resin and modified resins thereof.

The dry film thickness of the matte clear coating film is preferably from 10 to 50 μm. In the case where the dry film thickness is less than 10 μm, it is difficult to obtain a high-quality matte appearance, and in the case where it exceeds 50 μm, the appearance of the coating film may be deteriorated. The dry film thickness of the matte clear coating film is more preferably from 20 to 40 μm.

The matte agent used in the matte clear coating material may be various matte agents and is preferably at least one kind of resin fine particles or inorganic fine particles. Examples of the resin fine particles include an acrylic resin, polyacrylonitrile, polyurethane, polyamide and polyimide. The average particle diameter of the resin fine particles is preferably from 10 to 25 μm. In the case where the average particle diameter is less than 10 μm, a high-quality matte appearance may be insufficiently exhibited to provide a too smooth texture. In the case where the average particle diameter exceeds 25 μm, the surface of the matte clear coating film suffers coarse unevenness to provide a too rough texture.

Examples of the inorganic fine particles include silica fine particles, clay, talc and mica. The average particle diameter of the inorganic fine particles is preferably from 1 to 5 μm. In the case where the average particle diameter is less than 1 μm, a high-quality matte appearance may be insufficiently exhibited to provide a too smooth texture. In the case where the average particle diameter exceeds 5 μm, the surface of the matte clear coating film suffers coarse unevenness to provide a too rough texture. The resin fine particles and the inorganic fine particles may be used in combination. The ratios thereof is preferably from 0.001 to 100 parts by mass, and more preferably from 0.1 to 10 parts by mass, for the inorganic fine particles per 1 part by mass of the resin fine particles.

It is effective for design property that several kinds of the resin fine particles and the inorganic fine particles are used in combination in the matte clear coating material. The content of the matte agent is preferably from 10 to 60% by mass in terms of solid content based on the solid content of the coating material. In the case where the content is less than 10% by mass, a high-quality matte appearance may not be obtained, and in the case where it exceeds 60% by mass, the strength of the coating film may be insufficient. The content of the matte agent is more preferably from 25 to 50% by mass in terms of solid content.

The matte clear coating material may contain depending on necessity an additive, such as a coloring pigment, an extender pigment, a modifier, an ultraviolet ray absorbent, a leveling agent, a defoaming agent.

The matte clear coating material may be any one of an organic solvent type, an aqueous type, a powder type. The organic solvent type and aqueous type coating material may be a one-component type or a two-component type, such as a two-component urethane resin coating material. The matte clear coating film formed with the matte clear coating material is then baked at a temperature of from 120 to 160° C. for a prescribed period of time to finish the coating film.

The color clear coating material contains a vehicle and a coloring pigment. The vehicle may be one that has been ordinarily used as a finish coating, and for example, a mixture of a thermosetting resin and crosslinking agent may be used. The thermosetting resin may be at least one selected from an acrylic resin, a polyester resin, a fluorine resin, an epoxy resin, a polyurethane resin, a polyether resin and modified resins thereof. The color clear coating material may be various types, such as a solvent type, an aqueous type and a powder type. The solvent type coating material and the aqueous type coating material may be a one-component type or a two-component type resin, such as a two-component urethane resin coating material.

Examples of the coloring pigment used in the color clear coating material include an azo lake pigment, an insoluble azo pigment, a condensed azo pigment, a diketopyrrolopyrrol pigment, a benzimidazolone pigment, a phthalocyanine pigment, an indigo pigment, a perynone pigment, a perylene pigment, a phthalone pigment, a dioxazine pigment, a quinacridone pigment, an isoindolynone pigment and a metallic complex pigment as organic pigments, and yellow iron oxide, red iron oxide, carbon black and titanium dioxide as inorganic pigments. If necessary, an extender pigment, such as talc, calcium carbonate, precipitated barium sulfate and silica, may be used together in addition to the above coloring pigment.

The color clear coating material may contain an additive, such as a modifier, an ultraviolet ray absorbent, a leveling agent, a dispersing agent and a defoaming agent, in such a range that the transparency thereof is not impaired.

The dry film thickness of the color clear coating film is preferably from 10 to 80 μm, and in the case where the dry film thickness is outside the range, the appearance of the coating film may be insufficient. The dry film thickness of the color clear coating film is more preferably from 20 to 50 μm. In the method for forming a glittering material-containing coating film of the invention, a glittering coating film having a colored highly metallic appearance can be obtained by forming at least one layer of the color clear coating film on the glittering base coating film since light passing through the color clear coating film is reflected by the glittering base coating film, and the reflected light amplifies the glittering appearance.

Examples of the case where two or more layers of clear coating films are formed include a method of forming a color clear coating film on the glittering base coating film and further forming a transparent clear coating film, and a method of forming a transparent clear coating film on the glittering base coating film and further forming a color clear coating film, which may be appropriately selected depending on purposes.

### EXAMPLES

The invention will be described in more detail with reference to examples below, but the invention is not construed as being limited thereto.

### Production Example 1

### Preparation of Silver Colloid Solution

12 g of Disperbyk 190 (produced by BYK Chemie GmbH) as a polymeric pigment dispersing agent and 420.5 g of ion exchanged water were placed in a 2-L Kolben. The Kolben was placed in a water bath, and the content thereof was stirred at 50° C. until Disperbyk 190 was dissolved. 100 g of silver nitrate having been dissolved in 420.5 g of ion exchanged water was added thereto under stirring, and the content was further stirred at 70° C. for 10 minutes. 262 g of dimethylaminoethanol was added thereto. The liquid content was quickly changed in color to black, and the temperature of the liquid content was increased to 76° C. The liquid content was allowed to stand, and when the liquid temperature was decreased to 70° C., the liquid content was continuously stirred at that temperature for 2 hours to provide a silver colloid aqueous solution colored dark yellow. The resulting reaction solution was transferred to a plastic bottle of 1 L, which was allowed to stand in a constant temperature chamber at 60° C. for 18 hours. An ultrafiltration system was fabricated by connecting an ultrafiltration module (“AHP1010”, molecular weight cut off: 50,000, number of filters: 400, produced by Asahi Kasei Corporation), a magnet pump and a stainless steel cup of 3 L having tube connection ports at the lower part, with a silicone tube. The reaction solution having been allowed to stand in a constant temperature chamber at 60° C. for 18 hours was put into the stainless steel cup, and after adding 2 L of ion exchanged water thereto, the pump was operated to perform ultrafiltration. At the time when the amount of the filtrate discharged from the ultrafiltration module reached 2 L after a lapse of about 40 minutes, 2 L of ethanol was added to the stainless steel cup. Thereafter, it was confirmed that the conductivity of the filtrate was 300 μS/cm or lower, and the reaction solution was concentrated until the amount of the solution reached 500 mL. Subsequently, another ultrafiltration system was fabricated with a 500-mL stainless steel cup containing the solution, an ultrafiltration module (“AHP0013”, molecular weight cut off: 50,000, number of filters: 100, produced by Asahi Kasei Corporation), a tube pump and an aspirator. The solution thus prepared was placed in the stainless steel cup and was concentrated to increase the solid concentration. At the time when the amount of the solution reached about 100 mL, the tube pump was stopped to terminate the concentrating operation, whereby a silver colloid ethanol solution having a solid content of 30% was obtained. The average particle diameter of the silver colloid in the solution was 27 nm. The measurement with “TG-DTA” (produced by Seiko Instrument Corporation) showed that the content of the silver in the solid content was 96% by mass for 93% by mass of the initial charge.

### Production Example 2

### Synthesis of Resin for Forming Coating Film

40 parts by mass of propylene glycol monoethyl ether was charged in a Kolben equipped with a stirrer, a thermostat and a condenser tube, to which 100 parts by mass of a mixed monomer solution containing 8.86 parts by mass of styrene, 8.27 parts by mass of ethylhexyl acrylate, 15.00 parts by mass of lauryl methacrylate, 34.80 parts by mass of 2-hydroxyethyl methacrylate, 3.07 parts by mass of methacrylic acid and 30.00 parts by mass of acid phosphoxyhexa(oxypropylene)monomethacrylate (JAMP-100N, produced by Johoku Chemical Co., Ltd.), and 43 parts by mass of an initiator solution containing 3.0 parts by mass of tert-butyl peroctoate (Kayaester O) and 40 parts by mass of propylene glycol monoethyl ether were added dropwise at 115° C. over 3 hours, followed by continuously stirring for 30 minutes. Thereafter, 20.3 parts by mass of an initiator solution containing 0.3 part by mass of tert-butyl peroctoate (Kayaester O) and 20 parts by mass of propylene glycol monoethyl ether was added dropwise thereto over 1 hour, followed by further stirring for 1.5 hours. The coating film-forming resin A thus obtained had an acid value of 106 mgKOH/g, an acid value of phosphoric acid groups of 86 mgKOH/g, a hydroxyl value of 150, a number average molecular weight of 3,800 and a nonvolatile content of 49% by mass.

### Production Examples 3 to 7

### Synthesis of Resin for Forming Coating Film

The resins for forming a coating film B to F were produced in the same manner as in Production Example 2 except that the resins for forming a coating film were synthesized with the mixing amounts (part by mass) shown in Table 1 below.

TABLE 1

| | Production Example | | | | | |
|---|---|---|---|---|---|---|
| | 2 | 3 | 4 | 5 | 6 | 7 |
| Coating film-forming resin | A | B | C | D | E | F |
| Styrene | 8.86 | 8.86 | 8.86 | 8.86 | 8.86 | 8.86 |
| Methyl methacrylate | — | — | 22.68 | — | — | — |
| Ethylhexyl acrylate | 8.27 | 15.23 | 24.54 | 2.22 | 18.27 | 14.38 |
| Lauryl methacrylate | 15.00 | 15.00 | 15.00 | 15.00 | 15.00 | 15.00 |
| 2-Hydroxyethyl methacrylate | 34.80 | 27.84 | 13.92 | 13.92 | 34.80 | 41.76 |
| Methacrylic acid | 3.07 | 3.07 | — | — | 3.07 | — |
| Acid phosphoxy hexa(oxypropylene) | 30.00 | 30.00 | 15.00 | 60.00 | 20.00 | 20.00 |
| monomethacrylate | | | | | | |
| tert-Butyl peroctoate | 3.30 | 3.30 | 3.30 | 3.30 | 3.30 | 3.30 |
| Tg | 5.34 | −4.43 | −5.72 | −2.01 | −4.11 | −0.73 |
| Acid value of phosphoric acid groups | 85.50 | 85.50 | 42.75 | 171.00 | 57.00 | 57.00 |
| Acid value | 105.50 | 105.50 | 42.75 | 171.00 | 77.00 | 57.00 |
| Hydroxyl value | 150.00 | 120.00 | 60.00 | 60.00 | 150.00 | 180.00 |
| Number average molecular weight | 3,794 | 4,670 | 5,058 | 2,299 | 6,254 | 5,244 |

### Production Example 8

### Synthesis of Glittering Material-Containing Base Coating Material

5 parts by mass of the colloid solution (solid content: 1.5 parts by mass) obtained in Production example 1 and 0.31 part by mass of the coating film-forming resin A (solid content: 0.15 parts by mass) obtained in Production Example 2 were mixed. The mixture was diluted with 47 parts by mass of an organic solvent (containing butyl acetate, propylene glycol monomethyl ether and butyl cellosolve at a mass ratio of 5/4/1) to make a viscosity suitable for coating (13 seconds/#4 Ford cup, 20° C.), whereby a glittering material-containing base coating material was obtained. The resulting glittering material-containing base coating material had a solid content of 2% by mass upon coating.

### Example 1

A surface of an aluminum die-cast plate of JIS AC4C material having a dimension of 10 mm in thickness, 10 cm in length and 15 cm in width having been subjected to a zircon coating treatment was cut to form a glittering surface, on which an acrylic resin epoxy powder coating material, Biryusia HB2000 Clear, produced by Nippon Paint Co., Ltd. was electrostatically coated to a dry film thickness of 100 μm and then baked at 160° C. for 30 minutes to form a base coating film.

As an undercoating film, an acrylic melamine solvent type coating material, Super Lacq 5000 AS-70 Base Black, produced by Nippon Paint Co., Ltd., was spray-coated on the base coating film to a dry film thickness of 30 μm and then set for 5 minutes, followed by baking at 140° C. for 30 minutes, to form an undercoating film.

As a glittering material-containing base coating film, the glittering material-containing base coating material obtained in Production Example 8 was spray-coated on the undercoating film to a dry film thickness of 0.1 μm and then set for 10 minutes, followed by baking at 140° C. for 30 minutes, to form a glittering material-containing base coating film.

As a clear coating film, an acrylic melamine solvent type coating material, Super Lacq 5000 AW10 Clear, produced by Nippon Paint Co., Ltd., was spray-coated thereon to a dry film thickness of 30 μm and then set for 10 minutes, followed by baking at 140° C. for 30 minutes, to form a clear coating film. Thus, a multi-layer coating film was obtained.

### Examples 2 to 4 and Comparative Examples 1 to 8

Multi-layer coating films were formed in the same manner as in Production Example 8 and Example 1 except that the resins for forming a coating film and the baking conditions shown in Table 2 below were used.

The resulting multi-layer coating films were evaluated for water resistance by the following test. The results obtained are shown in Table 2.

### Water Resistance Test (Secondary Adhesiveness)

The multi-layer coating film was immersed in warm water at 60° C. for 72 hours, and a cross-cut grid having 100 squares of 2 mm×2 mm was formed on the coating film with a cutter knife. A cellophane adhesive tape was applied on the surface of the squares and then peeled off quickly. The number of the squares remaining on the coating film was counted.

### Appearance After Water Resistance Test

The appearance of the multi-layer coating film after immersing in warm water at 60° C. for 72 hours was evaluated by the following standard.
5: no blister found
4: microblister found
3: blister slightly found
2: blister found
1: blister significantly found

TABLE 2

| | Example | | | | Comparative Example | | | | | | | |
|---|---|---|---|---|---|---|---|---|---|---|---|---|
| | 1 | 2 | 3 | 4 | 1 | 2 | 3 | 4 | 5 | 6 | 7 | 8 |
| Coating film-forming resin | A | A | B | B | C | C | D | D | E | E | F | F |
| Baking conditions | a | b | a | b | a | b | a | b | a | b | a | b |
| Water resistance test | 100/100 | 100/100 | 100/100 | 100/100 | 0/100 | 0/100 | 100/100 | 21/100 | 90/100 | 0/100 | 98/100 | 54/100 |
| (secondary adhesiveness) | | | | | | | | | | | | |
| Appearance after water | 5 | 5 | 5 | 5 | 5 | 5 | 5 | 5 | 5 | 5 | 4 | 1 |
| resistance test | | | | | | | | | | | | |

Baking Conditions:
a: 140° C. for 30 minutes
b: 160° C. for 20 minutes

### Examples 5 and 6 and Comparative Examples 9 to 11

Glittering material-containing coating materials and multi-layer coating films were formed in the same manner as in Production Example 8 and Example 1 except that the mixed solvents shown in Table 3 below were used.

TABLE 3

| | | Boiling | | | Comparative | | |
|---|---|---|---|---|---|---|---|
| | | point | Example | | Example | | |
| Solvent | | (° C.) | 5 | 6 | 9 | 10 | 11 |
| Ester | Butyl acetate | 126 | 40 | 40 | 45 | 60 | — |
| Glycol | Ethylene glycol | 136 | — | 40 | — | — | — |
| | monoethyl ether | | | | | | |
| | Ethylene glycol | 171 | 20 | 20 | — | — | 20 |
| | monobutyl ether | | | | | | |
| | Propylene glycol | 120 | 40 | — | 35 | 20 | — |
| | monomethyl ether | | | | | | |
| Others | Methyl isobutyl ketone | 118 | — | — | — | — | 40 |
| | Xylene | 144 | — | — | — | — | 40 |
| | S-150 | 190 | — | — | 20 | 20 | — |

S-150: aromatic organic solvent, produced by Exxon Corp.

The glittering material-containing coating materials and the multi-layer coating films thus obtained were subjected to the following measurements and tests. The results obtained are shown in Table 4 below.

### Pimples Upon Coating

Pimples formed upon coating the multi-layer coating film were evaluated by the following standard.
5: no pimple found upon coating
4: substantially no pimple found upon coating
3: pimples slightly found upon coating
2: some pimples found upon coating
1: pimples found upon coating

### Glossiness

The 60° glossiness was measured with Picogloss Model 500MC, produced by Erichsen GmbH.

### Storage Stability

The glittering material-containing base coating materials obtained in Production Example 3 were stored at 40° C., and after lapsing 1 month, the states thereof were observed to evaluate for storage stability by the following standard.
5: no change
4: slightly separated
3: soft precipitate slightly found
2: soft precipitate found
1: precipitate found

TABLE 4

| | Example | | Comparative Example | | |
|---|---|---|---|---|---|
| | 5 | 6 | 9 | 10 | 11 |
| 60° gloss | 450 | 430 | 330 | 310 | 380 |
| Pimples upon coating | 5 | 5 | 1 | 1 | 3 |
| Storage stability | 5 | 5 | 1 | 1 | 1 |

The glittering material-containing base coating material used in the invention contains a resin for forming a coating material having an acid value of phosphoric acid groups, a total acid value, a hydroxyl value and a number average molecular weight that are in the particular ranges. As a result, the multi-layer coating film formed by using the glittering material-containing base coating material has excellent water resistance. The use of an organic solvent that is suitable for dispersing the coating film-forming resin and the colloid particles provides excellent storage stability and excellent appearance of the coating film (pimples upon coating). The organic solvent contains the combination of solvents having different boiling points, and thus the coating film forming property thereof can be controlled. Accordingly, the change in coating environment can be easily treated by adjusting the composition of the solvent, whereby a coating film excellent in design property can be stably formed.

According to the invention, a method for forming a multi-layer coating film having metallic gloss excellent in design property is provided.

1. A method for forming a multi-layer coating film by forming an undercoating film, a glittering material-containing base coating film and a clear coating film in this order on a substrate to be coated,
a glittering material-containing base coating material for forming the glittering material-containing base coating film containing colloid particles containing a noble metal and/or a metal, a coating film-forming resin, and a mixed solvent containing an ester organic solvent having a boiling point of from 70 to 130° C. and a glycol or glycol ether organic solvent having a boiling point of from 115 to 230° C. at a mass mixing ratio of from 2/8 to 5/5,
the coating film-forming resin containing a phosphoric acid group-containing acrylic resin having an acid value of phosphoric acid groups of from 70 to 150 mgKOH/g, a total acid value including acid values of other acid groups of from 70 to 200 mgKOH/g, a hydroxyl value of from 50 to 220 mgKOH/g and a number average molecular weight of from 2,000 to 8,000, in an amount of from 30 to 100% by mass in terms of solid content.

2. The method for forming a multi-layer coating film as claimed in claim 1, wherein the ester organic solvent having a boiling point of from 70 to 130° C. is at least one organic solvent selected from the group consisting of ethyl acetate, isopropyl acetate, butyl acetate, isobutyl acetate, methyl propionate and propyl acetate, and the glycol or glycol ether organic solvent having a boiling point of from 115 to 230° C. is at least one organic solvent selected from the group consisting of ethylene glycol monomethyl ether, ethylene glycol monoethyl ether, ethylene glycol isopropyl ether, ethylene glycol 2-ethylhexyl ether, 3-methyl-3-methoxybutanol, 3-methoxybutanol, ethylene glycol monohexyl ether, ethylene glycol monobutyl ether, diethylene glycol monomethyl ether, diethylene glycol monoethyl ether, diethylene glycol monoethyl ether acetate, propylene glycol monomethyl ether and propylene glycol monoethyl ether.

3. A glittering material-containing base coating material used in the method for forming a multi-layer coating film as claimed in claim 1.

4. A glittering material-containing base coating material used in the method for forming a multi-layer coating film as claimed in claim 2.
